(19) United States
(12) Patent Application Publication
(10) Pub. No.: US 2011/0290968 A1
(43) Pub. Date: Dec. 1, 2011

(54) MOUNTING ASSEMBLY

(75) Inventors: Michael R. Maughan, Moscow, ID (US); Eric Broncheau, Moscow, ID (US)

(73) Assignee: IVUS INDUSTRIES, LLC, Moscow, ID (US)

(21) Appl. No.: 13/117,414

(22) Filed: May 27, 2011

Related U.S. Application Data
(60) Provisional application No. 61/349,019, filed on May 27, 2010.

(51) Int. Cl. F16M 13/02; F16B 2/10

(52) U.S. Cl. 248/231.51

(57) ABSTRACT

A mounting assembly configured for mounting to a generally T-shaped rail or similar mount. The mounting assembly comprising a housing, a first arm, and a latching arm assembly. The first arm extending from the housing. The first arm comprising a first jaw. The latching arm assembly connected to the housing.

### PRIORITY/CROSS-REFERENCE TO RELATED APPLICATIONS

This application claims the benefit of U.S. Provisional Application No. 61/349,019, filed 27 May 2010, the disclosure of which is incorporated by reference.

### TECHNICAL FIELD

The disclosure generally relates to the field of mounting assemblies. Exemplary mounting assemblies disclosed relate to mounts for mounting an accessory on a firearm or other tactical device.

### BACKGROUND

Military and law enforcement personnel rely on a variety to tools to accomplish their assignments. One such tool is the weapon mounted light. Weapon mounted lights have long been used as a means to accomplish the task at hand more simply than if the user were to hold on to a weapon as well as a separate flashlight.

Weapon mounted lights take any number of forms but typically follow two basic architectures: (1) the weapon mounted light is separate from the weapon, and is adapted for mounting on the weapon with a mechanism or holder which mounts on the light in some way, and (2) the weapon mounted light has an integral, dedicated attachment mechanism allowing the weapon mounted light to be attached to the weapon.

It is beneficial for the weapon mounted light to be easily and quickly removed from and mounted to the weapon. The connection should be sturdy and able to withstand significant impacts without changing the direction that the light is pointing. Further, it is advantageous for the weapon mounted light to be compact and not significantly change the shape or handling of the weapon.

Many devices include a rail structure configured for attachment to a mounting assembly. For instance, many weapons/firearms have a rail, commonly referred to as a Picatinny rail, a Weaver rail mount, and/or a “floating rail” structure, to which accessories can be mounted. Such accessories including, but not limited to, flashlights, lasers, and additional weapons.

U.S. Pat. No. 7,685,759 describes a “conventional Picatinny rail mount structure” as having a “plurality of mounting members, each having a generally T-shaped cross-section, angularly spaced about the long axis of the structure and extending radially outward. The opposite transverse edges of the mounting members are beveled to form proximally inclined surface which are generally outwardly facing, and distal inclined surfaces which are angled with respect to the respective surfaces.”

### SUMMARY OF THE DISCLOSURE

Several exemplary mounting assemblies are described herein.

An exemplary mounting assembly comprises a housing, a first arm, and a latching arm assembly. The first arm defines a first jaw. The first arm connecting to the housing. The latching arm assembly comprises a latch release lever, a toggle link, and a latching arm. The latching arm connecting to the housing. The toggle link defines a first end and a second end. The toggle link first end pivotally connecting to the housing. The toggle link second end pivotally connecting to the latch release lever. The latch release lever pivotally connecting to the latching arm. The latching arm defines a latching jaw. The latching arm assembly comprising an over center, toggle link style mechanism. When mounted on a rail, the rail is held clamped between the first jaw and the latching jaw.

Another exemplary mounting assembly is configured for mounting to a generally T-shaped rail. The mounting assembly comprising a housing, a first arm, and a latching arm assembly. The first arm extending from the housing. The first arm comprising a first jaw. The latching arm assembly pivotally connected to the housing. The latching arm assembly comprising a latch release lever, a latching arm, and a toggle link. The toggle link defines a first end and a second end. The first end pivotally connecting to a first toggle link receiver defined in the housing at a fourth pivot point. The second end pivotally connecting to a second toggle link receiver defined in the latch release lever at a third pivot point. The latch release lever pivotally connecting to the latching arm at a first pivot point. The latch release lever defines an open position and a closed position. The latch release lever defines an upper end and a lower end. The latching arm defines a latching jaw. The latching arm pivotally connecting to the housing at a second pivot point. The latch release lever upper end can be manipulated by a user in a first direction from the closed position to the open position. When moved in the first direction, the latch release lever pivots around the first pivot point resulting in rotation of the latch arm at the second pivot point causing the latching jaw to move away from the first jaw. The latch release lever upper end can be manipulated by a user in a second direction from the open position to the closed position. When moved in the second direction, the latch release lever pivots around the first pivot point resulting in rotation of the latch arm at the second pivot point causing the latching jaw to move towards the first jaw. When in the closed position, the T-shaped rail is clamped between the latching jaw and the first jaw.

Another exemplary mounting assembly is configured for mounting to a generally T-shaped rail. The exemplary mounting assembly comprises a housing, a first arm and a latching arm assembly. The first arm extending from the housing. The first arm comprising a first jaw. The latching arm assembly pivotally connected to the housing. The latching arm assembly comprising a latch release lever, a latching arm, and a toggle link. The toggle link defines a first end and a second end. The first end pivotally connecting to a first toggle link receiver defined in the housing at a fourth pivot point. The second end pivotally connecting to a second toggle link receiver defined in the latch release lever at a third pivot point. The latch release lever pivotally connecting to the latching arm at a first pivot point. The latch release lever defines an open position and a closed position. The latch release lever defines an upper end and a lower end. The latching arm defines a latching jaw. The latching arm pivotally connecting to the housing at a second pivot point. The latch release lever upper end can be manipulated by a user in a first direction from the closed position to the open position. When moved in the first direction, the latch release lever pivots around the first pivot point resulting in rotation of the latch arm at the second pivot point causing the latching jaw to move away from the first jaw. The latch release lever upper end can be manipulated by a user in a second direction from the open position to the closed position. When moved in the second direction, the latch release lever pivots around the first pivot point resulting in rotation of the latch arm at the second pivot point causing the latching jaw to move towards the first jaw. When in the closed position, the T-shaped rail is clamped between the latching jaw and the first jaw. When moving from the open position to the closed position, the first pivot passes between the third pivot point and the fourth pivot point. When in the closed position, the first pivot point is in an over-center lock position.

Another exemplary mounting assembly is configured for mounting to a generally T-shaped rail. The mounting assembly comprises a housing, a first arm and a latching arm assembly. The housing comprises an illumination means. The first arm extending from the housing. The first arm comprising a first jaw. The first jaw defining a first notch and a second notch. The notches configured for mating with opposing flanges extending from the T-shaped rail. The latching arm assembly pivotally connected to the housing. The latching arm assembly comprising a latch release lever, a latching arm, and a toggle link. The toggle link defines a first end and a second end. The first end pivotally connecting to a first toggle link receiver defined in the housing at a fourth pivot point. The second end pivotally connecting to a second toggle link receiver defined in the latch release lever at a third pivot point. The latch release lever pivotally connecting to the latching arm at a first pivot point. The latch release lever defines an open position and a closed position. The latch release lever defines an upper end and a lower end. The latching arm defines a latching jaw. The latching arm pivotally connecting to the housing at a second pivot point. The latch release lever upper end can be manipulated by a user in a first direction from the closed position to the open position. When moved in the first direction, the latch release lever pivots around the first pivot point resulting in rotation of the latch arm at the second pivot point causing the latching jaw to move away from the first jaw. The latch release lever upper end can be manipulated by a user in a second direction from the open position to the closed position. When moved in the second direction the latch release lever pivots around the first pivot point resulting in rotation of the latch arm at the second pivot point causing the latching jaw to move towards the first jaw. When in the closed position, the T-shaped rail is clamped between the latching jaw and the first jaw. When moving from the closed position to the open position, the first pivot point passes between the third and fourth pivot points, rotates relative to the third pivot point, and moves away from the fourth pivot point. When moving from the open position to the closed position, the first pivot passes between the third pivot point and the fourth pivot point. When in the closed position, the first pivot point is in an over-center lock position.

In another exemplary mounting assembly, the mounting assembly is configured for mounting to a generally T-shaped rail. The mounting assembly comprises a housing, a first arm and a latching arm assembly. The first arm extends from the housing. The first arm comprises a first jaw. The latching arm assembly is connected to the housing at a connection point. The latching arm assembly comprises a latch release lever, a latching arm, and a toggle link. The toggle link has a first end and a second end. The first end is pivotally connected to a first toggle link receiver defined in the housing at a fourth pivot point. The second end pivotally connects to a second toggle link receiver defined in the latch release lever at a third pivot point. The latch release lever is pivotally connected to the latching arm at a first pivot point. The latch release lever has an open position and a closed position. The latch release lever has an upper end and a lower end. The latching arm has a latching jaw. The latch release lever upper end can be manipulated by a user in a first direction from the closed position to the open position. When moved in the first direction, the latch release lever pivots around the first pivot point resulting in movement of the latching arm at the connection point, thereby causing the latching jaw to move away from the first jaw; The latch release lever upper end can be manipulated by a user in a second direction from the open position to the closed position. When moved in the second direction, the latch release lever pivots around the first pivot point resulting in movement of the latching arm at the connection point thereby causing the latching jaw to move towards the first jaw. When in the closed position, the T-shaped rail is clamped between the latching jaw and the first jaw.

In another exemplary mounting assembly, the mounting assembly is configured for mounting to a generally T-shaped rail. The mounting assembly comprises a housing, a first arm and a latching arm assembly. The first arm extends from the housing. The first arm comprises a first jaw. The latching arm assembly connects to the housing at a connection point. The latching arm assembly comprises a latch release lever, a latching arm, and a toggle link. The toggle link has a first end and a second end. The first end is pivotally connected to a first toggle link receiver defined in the housing at a fourth pivot point. The second end is pivotally connected to a second toggle link receiver defined in the latch release lever at a third pivot point. The latch release lever is pivotally connected to the latching arm at a first pivot point. The latch release lever has an open position and a closed position. The latch release lever has an upper end and a lower end. The latching arm has a latching jaw. The latch release lever upper end can be manipulated by a user in a first direction from the closed position to the open position. When moved in the first direction, the latch release lever pivots around the first pivot point, resulting in movement of the latching arm at the connection point, thereby causing the latching jaw to move away from the first jaw. The latch release lever upper end can be manipulated by a user in a second direction from the open position to the closed position. When moved in the second direction, the latch release lever pivots around the first pivot point, resulting in movement of the latching arm at the connection point, thereby causing the latching jaw to move towards the first jaw. When in the closed position, the T-shaped rail is clamped between the latching jaw and the first jaw. When moving from the open position to the closed position, the first pivot passes between the third pivot point and the fourth pivot point. When in the closed position, the first pivot point is in an over-center lock position.

Additional understanding of the devices contemplated and/or claimed by the inventors can be gained by reviewing the detailed description of exemplary devices, presented below, and the referenced drawings.

### BRIEF DESCRIPTION OF THE DRAWINGS

FIG. 1 is a perspective view of a first exemplary mounting assembly.

FIG. 2 is a second perspective view of the exemplary mounting assembly of FIG. 1.

FIG. 3 is a partial, exploded, perspective view of the exemplary mounting assembly of FIG. 1.

FIG. 4 is a plan view of the exemplary mounting assembly of FIG. 1.

FIG. 5 is a cross-sectional view of the exemplary mounting assembly of FIG. 1.

FIG. 6 is a side, partial environmental view of the exemplary mounting assembly of FIG. 1 shown adjacent a firearm having a mounting rail.

FIG. 7 is an end view of the exemplary mounting assembly of FIG. 6.

FIG. 8 is an end view of the exemplary mounting assembly of FIG. 6, showing the mounting assembly in the process of being attached to the firearm having a mounting rail.

FIG. 9 is an end view of the exemplary mounting assembly of FIG. 6, showing the mounting assembly further in the process of being attached to the firearm having a mounting rail.

FIG. 10 is an end view of the exemplary mounting assembly of FIG. 6, showing the mounting assembly attached to the firearm having a mounting rail.

FIG. 11 is a partial, environmental, perspective view of the first exemplary mounting assembly of FIG. 1, shown mounted upon a firearm having a mounting rail.

FIG. 12 is a third perspective view of the first exemplary mounting assembly of FIG. 1, showing the tail cap open.

FIG. 13 is a perspective view of a second exemplary mounting assembly.

FIG. 14 is a second perspective view of the second exemplary mounting assembly of FIG. 13.

FIG. 15 is an exploded, perspective view of the second exemplary mounting assembly of FIG. 13.

FIG. 16 is a cross-sectional, perspective view of the second exemplary mounting assembly of FIG. 13.

FIG. 17 is an end view of the second exemplary mounting assembly of FIG. 16.

FIG. 18 is an end view of the second exemplary mounting assembly of FIG. 16, showing the mounting assembly in the process of being attached to the firearm having a mounting rail.

FIG. 19 is an end view of the second exemplary mounting assembly of FIG. 16, showing the mounting assembly further in the process of being attached to the firearm having a mounting rail.

FIG. 20 is an end view of the second exemplary mounting assembly of FIG. 16, showing the mounting assembly attached to the firearm having a mounting rail.

### DETAILED DESCRIPTION

The following description and the referenced drawings provide illustrative examples of that which the inventors regard as their invention. As such, the embodiments discussed herein are merely exemplary in nature and are not intended to limit the scope of the invention, or its protection, in any manner. Rather, the description and illustration of these embodiments serve to enable a person of ordinary skill in the relevant art to practice the invention.

The use of “e.g.,” “etc,” “for instance,” “in example,” and “or” and grammatically related terms indicates non-exclusive alternatives without limitation, unless otherwise noted.

The use of “including,” “include,” and grammatically related terms means “including, but not limited to,” unless otherwise noted.

The use of the articles “a,” “an” and “the” are meant to be interpreted as referring to the singular as well as the plural, unless the context clearly dictates otherwise. Thus, for example, reference to “a pin” includes two or more such pins, and the like.

The use of “exemplary” and grammatically related terms means “an example of” and is not intended to convey a meaning of an ideal or preferred embodiment.

The use of “illumination means” and grammatically related terms is intended to include tactical lights (e.g., flashlights), ultra-violet (UV) illuminators, infrared (IR) illuminators, and laser aiming modules, unless the context clearly dictates otherwise.

The use of “accessory” and grammatically related terms is intended to include tactical lights, laser aiming modules, night vision devices, reflex sights, fore grips, bipods, bayonets, and scopes, unless the context clearly dictates otherwise.

The use of “mount” and grammatically related terms is intended to include rail mounts, Picatinny rail mounts, Weaver rail mounts, and “floating rail” mounts, unless the context clearly dictates otherwise.

The use of “connecting” and grammatically related terms is intended, in addition to its ordinary meaning, to mean directly or indirectly connected, including but not limited to pivotal connections and slidable connections, unless the context clearly dictates otherwise.

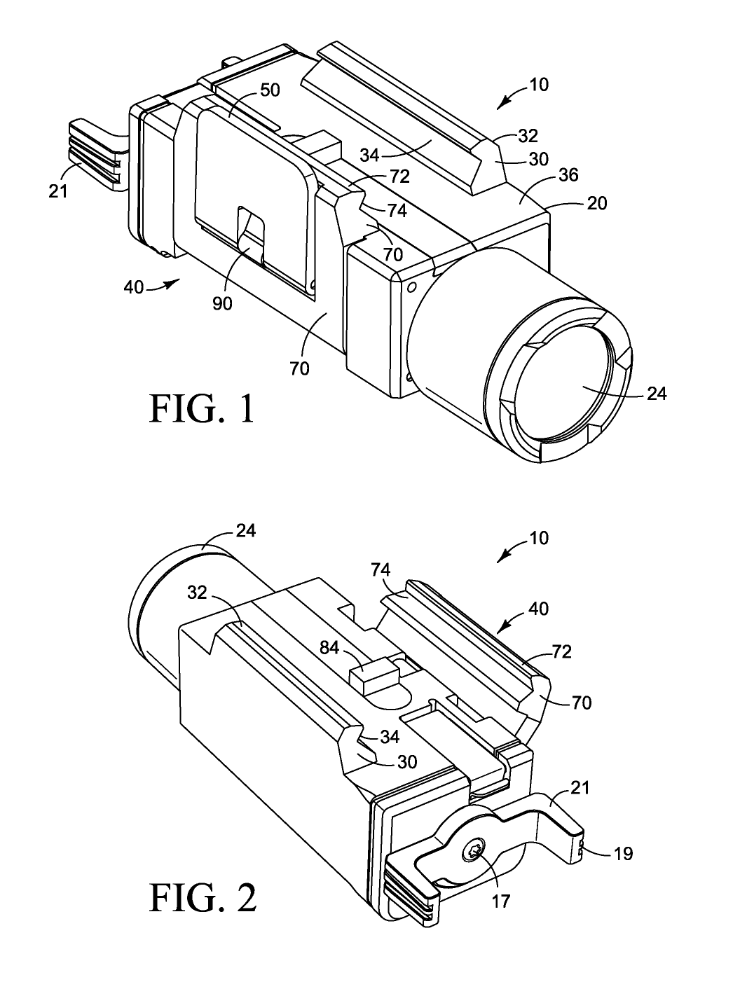

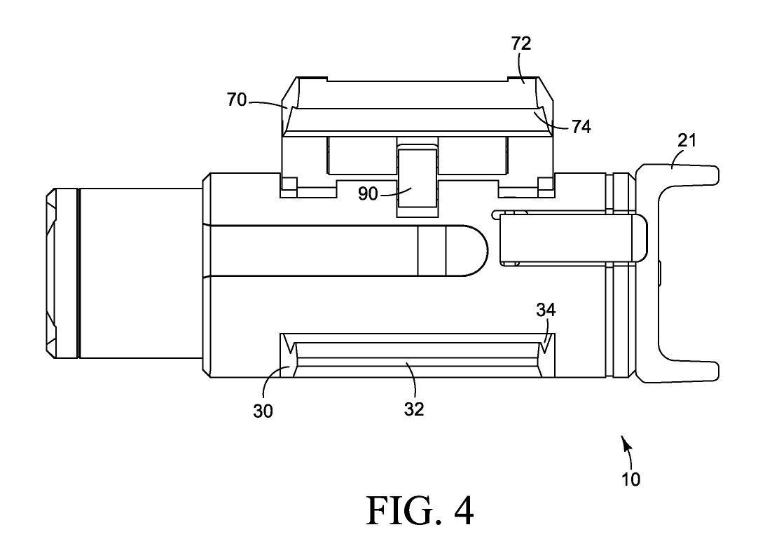

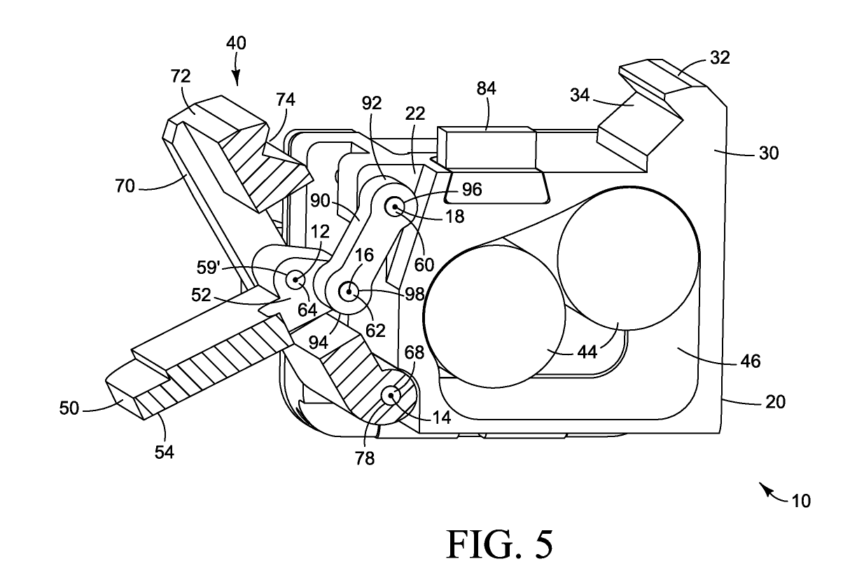

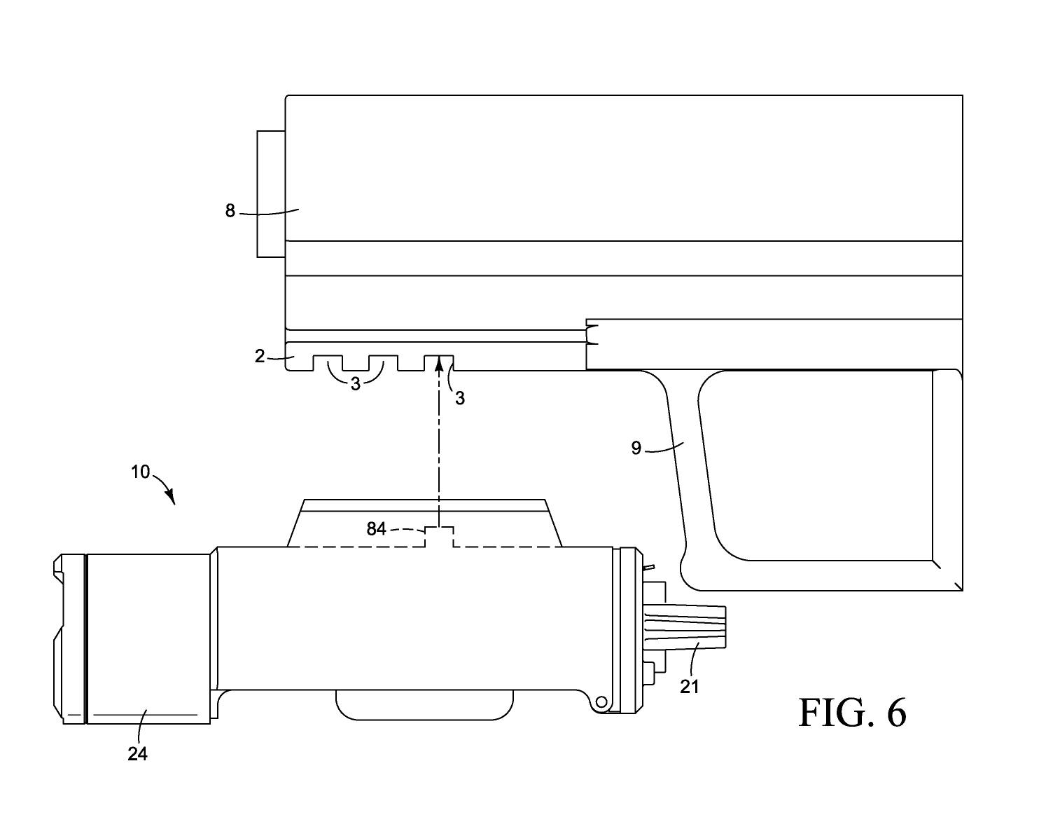

FIGS. 1 through 12 illustrate a first exemplary mounting assembly 10. The mounting assembly 10 comprises a housing 20, a first arm 30, and a latching arm assembly 40. The mounting assembly 10 for mounting an accessory to a mount, such as the T-shaped rail 2 shown in FIGS. 6 through 11. The housing 20 for housing an accessory and/or connecting with an accessory, such as the illumination means 24. The illumination means 24 can include a front bezel portion which contains a parabolic reflector for directing light from the illumination means 24 in a preferred direction. The mounting assembly 10 thereby allowing the accessory to be mounted onto a mount.

In the first exemplary mounting assembly 10, the accessory comprises an illumination means 24 controlled through use of switch means 21, and powered by energy storage device(s) 44. The switch means 21 shown comprising at least one switch arm 19 able to be manipulated by an operator. Movement (rotation) of the switch arm 19 relative to the switch center pivot 17 allowing the illumination means 24 to be turned on/off, and/or other modes of operation to be selected (e.g., variations of brightness, flashing).

The housing 20 further comprising a tail cap 23 which may be opened via door release latch 88 to access an internal chamber 46 for holding one or more energy storage device(s) 44 for powering an illumination means 24 or other accessory.

FIGS. 1 through 12 illustrate the housing 20 comprising a mounting alignment key 84 located on the top side of the housing 20. This mounting alignment key 84 for receipt into a transversely extending channel 3 (as shown in FIG. 6) located on the T-shaped rail 2 of the firearm 8. The mounting alignment key 84 for allowing the user to select a desired lateral location of the attached device on the rail 2.

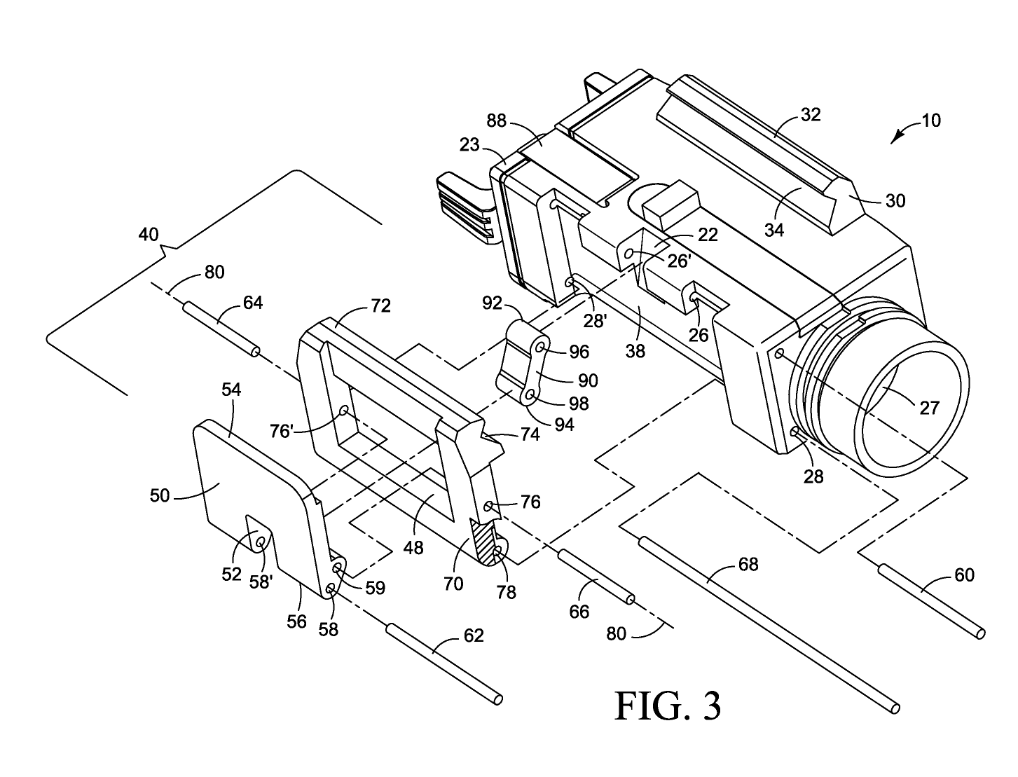

FIG. 3 illustrates the exemplary mounting assembly in exploded fashion. The illumination means 24 is not illustrated in FIG. 3. Instead, illustrated is the housing 20 comprising a housing chamber 27 defined therein into which at least a portion of the illumination means 24 might extend. The housing chamber 27 further defining an internal chamber 46 for receiving the energy storage device(s) 44 (e.g., batteries, ultracapacitors), or other components related to the illumination means 24 therein. The energy storage device(s) 44 for powering the illumination means. It is advantageous for the energy storage device(s) 44 to be interconnected with the switch 21 to control operation of the illumination means 24.

The first arm 30 extending away from the housing 20. The first arm 30 extending away from the top portion 36 of the housing 20. The first arm 30 comprising a first jaw 32 and a first notch 34.

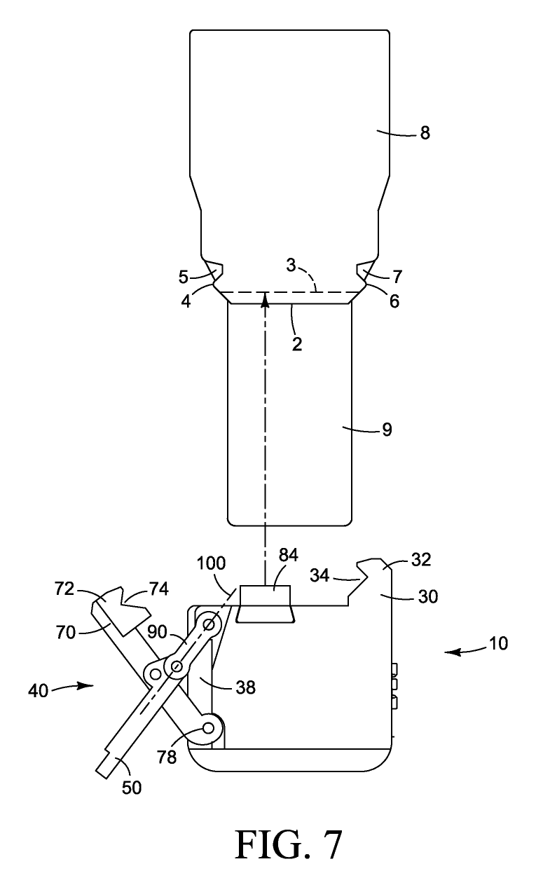

As illustrated best in FIGS. 7 through 10, the first jaw 32 configured for mating with a corresponding notch 7 on the T-shaped rail 2. The first notch 34 configured for mating with a corresponding opposing flange 6 on the T-shaped rail 2.

The latching arm assembly 40 comprising an over center, toggle link style mechanism, comprising a latch release lever 50, a toggle link 90, and a latching arm 70. The latching arm assembly 40 being connected to the housing 20 at a connection point. The connection point illustrated in FIGS. 1 through 12 being a pivotal connection.

The toggle link 90 comprising a first end 92 and a second end 94. The first end 92 defining a first end aperture 96 there-through, and said second end 94 defining a second end aperture 98 there-through. The first end aperture 96 configured for receiving an upper housing pin 60 there-through. The second end aperture 98 configured for receiving a toggle pin 62 there-through. The longitudinal axis of the upper housing pin 60 when extending through said first end aperture 96 defining a fourth pivot point 18. The longitudinal axis of the toggle pin 62 when extending through said second end aperture 98 defining a third pivot point 16.

The first end 92 pivotally connected to the housing 20. The second end 94 pivotally connected to the latch release lever 50. The latch release lever 50 pivotally connected to the latching arm 70. The latching arm 70 connected to the housing 20.

In the exemplary embodiment illustrated in FIGS. 1 through 12, the first end 92 configured for receipt into a first toggle link receiver 22 defined in the housing 20. The housing 20 defining at least one upper housing aperture 26, 26′ configured for receiving an upper housing pin 60 there-through. The upper housing pin 60 is able to extend through a first upper housing aperture 26, through the first end aperture 96 and into a second upper housing aperture 26′, thereby pivotally connecting the first end 92 to the housing 20 at the first toggle link receiver 22 and defining the fourth pivot point 18.

The second end 94 can be configured for receipt into a second toggle link receiver 52 defined in the latch release lever 50 at the lower end 56 of the latch release lever 50. The latch release lever 50 defining at least one outer aperture 58, 58′ configured for receiving a toggle pin 62 there-through. The toggle pin 62 is able to extend through an outer aperture 58, through the second end aperture 98, and into the outer aperture 58′, thereby pivotally connecting the second end 94 to the latch release lever 50 at the second toggle link receiver 52 and defining the third pivot point 16.

The latch release lever 50 comprising an upper end 54 and a lower end 56. The lower end 56 defining at least one outer aperture 58 and at least one inner aperture 59 there-through. The outer aperture 58 configured for receiving a toggle pin 62 there-through. The inner aperture 59 configured for receiving a second latch pin 66 there-through.

The latch release lever 50 pivotally connected to the latching arm 70. The latch release lever 50 configured for receipt into a latch release lever receiver 48 defined in the latching arm 70. The latching arm 70 defining a first center latching arm aperture 76′ there-through and a second center latching arm aperture 76 there-through. The first center latching arm aperture 76′ configured for receiving a first latch pin 64 there-through. The second center latching arm aperture 76 configured for receiving a second latch pin 66 there-through. The first latch pin 64 is able to extend through the first center latching arm aperture 76′ and into the inner aperture 59′ of the latch release lever 50, defining the first pivot point 12. The second latch pin 66 is able to extend through the second center latching arm aperture 76 and into the inner aperture 59 of the latch release lever 50. The first and center latching arm apertures aligned along a longitudinal axis 80, as best illustrated in FIG. 3, thereby jointly defining the first pivot point 12.

The latching arm 70 pivotally connected to the housing 20. The latching arm 70 configured for receipt into a latching arm receiver 38 defined in said housing. The latching arm 70 defining at least one bottom aperture 78 defined there-through, configured for receiving a lower housing pin 68 there-through. The lower housing pin 68 is able to extend through a first lower housing aperture 28 in the housing 20, through the at least one bottom aperture 78, and into the second lower housing aperture 28′ in the housing 20, thereby pivotally connecting the latching arm 70 to the housing 20 at the latching arm receiver 38 and defining the second pivot point 14.

The latching arm 70 comprising a latching jaw 72 and a second notch 74. The latching jaw 72 configured for mating with a corresponding notch 5 on the T-shaped rail 2. The second notch 74 configured for mating with a corresponding opposing flange 4 on the T-shaped rail 2. FIGS. 7 through 10 best illustrate this structure and connection.

The latch release lever 50 has an open position and a closed position. FIGS. 1, 10, 11 and 12 show the closed position; whereas FIGS. 2, 4, 7 and 8 show the open position. FIG. 9 illustrates an intermediary position where the latch release lever 50 is moved from the open position to the closed position.

FIGS. 6 though 11 illustrate exemplary steps for mounting the mounting assembly on a firearm 8 having a T-shaped rail 2. In FIGS. 6 and 7, the mounting assembly 10 is positioned adjacent the T-shaped rail 2. If present, the mounting alignment key 84 would be aligned with a desired transversely extending channel 3 and inserted therein. Some other exemplary mounting assemblies do not utilize a mounting alignment key 84. The firearm 8 shown in FIGS. 6 and 7 comprising a trigger guard 9 in front of which the mounting assembly 10 is positioned. In such a configuration, the switch 21 is located adjacent the trigger area of the firearm, allowing a user to easily activate the accessory. Some other exemplary mounting assemblies may be configured for mounting at other locations on the firearm 8.

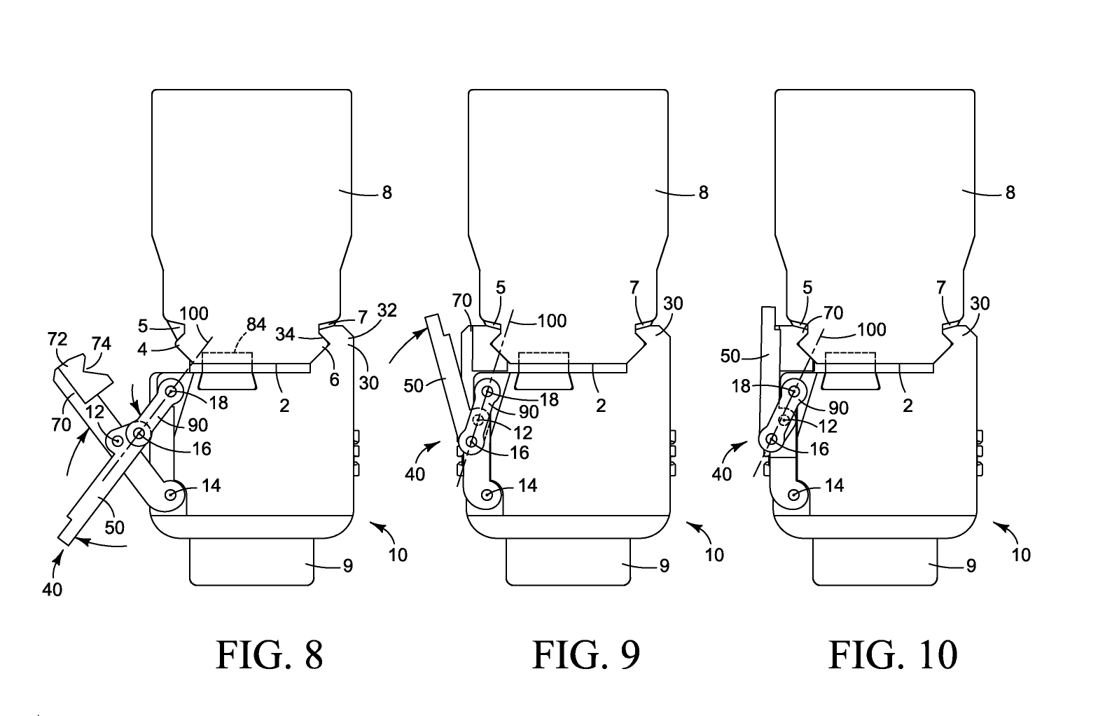

FIG. 8 showing the first jaw 32 received into the notch 7 and the opposing flange 6 received into the first notch 34. The latch release lever 50 is shown in its open position. Arrows represent movement of the latch release lever 50 and the corresponding movement of the latching arm 70 and the toggle link 90.

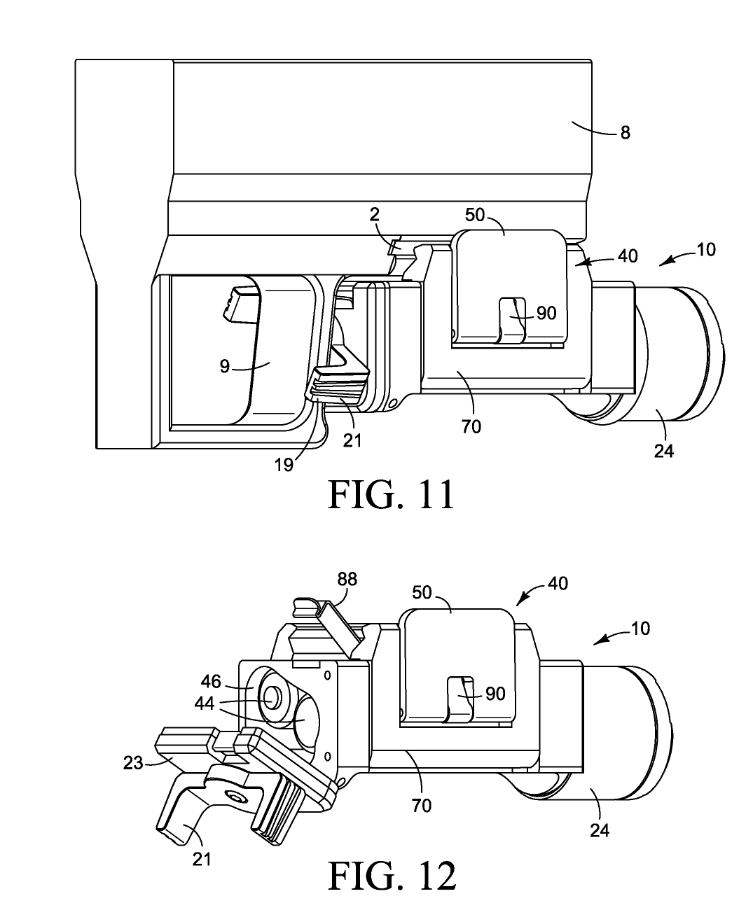

As shown in the transition from FIG. 8 to FIG. 9, as the latch release lever 50 is moved in a second direction, the latch release lever 50 rotates around the first pivot point 12 where the latch release lever 50 connects with the latching arm 70. The latch release lever 50 pivotally connects with the toggle link 90 at the third pivot point 16. Rotation around the first pivot point 12 results in rotation of the third pivot point 16 relative to the first pivot point 12. Rotation of the third pivot point 16 relative to the first pivot point 12 causes the second end 94 of the toggle link 90 to be drawn towards the housing 20 thereby drawing the latching arm 70, rotating at the second pivot point 14, towards the T-shaped rail 2 (and towards the first jaw 32), bringing the latching jaw 72 and second notch 74 into engagement with the notch 5 and opposing flange 4 of the rail 2, as best illustrated in FIG. 9. FIG. 11 showing the mounting assembly 10 mounted on the T-shaped rail 2 of a firearm 8.

Further movement of the latch release lever 50 in a first direction to the closed position, as shown in FIG. 10, results in the third pivot point rotating around the first pivot point 12 and bringing the first pivot point 12 into an over-center position relative to the toggle link axis 100. The toggle link axis 100 defined between the third pivot point 16 and the fourth pivot point 18. In this over-center position, the latch release lever 50 is locked into its closed position, with the latching jaw 72 and first jaw 32 releasably clamped onto the T-shaped rail 2 between the latching jaw 72 and the first jaw 32.

To detach the mounting assembly 10 from the firearm 8, the process is reversed, with the upper end 54 of the latch release lever 50 moved away from the housing and into its open position, resulting in the latching jaw 74 moving away from the first notch 34, and the first pivot point 12 moving out of its over-center position relative to the toggle link axis 100. Further movement of the latch release lever 50 away from the housing (rotating the latch release lever 50 around the first pivot point 12, results in the latching jaw 73 disengaging from the T-shaped rail 2 and moving away there-from. FIG. 12 illustrates a tail cap 23 which may be opened via door release latch 88 to access the internal chamber 46 for holding the energy storage device(s) 44. The energy storage device(s) 44 for powering the accessory (e.g., illumination means 24).

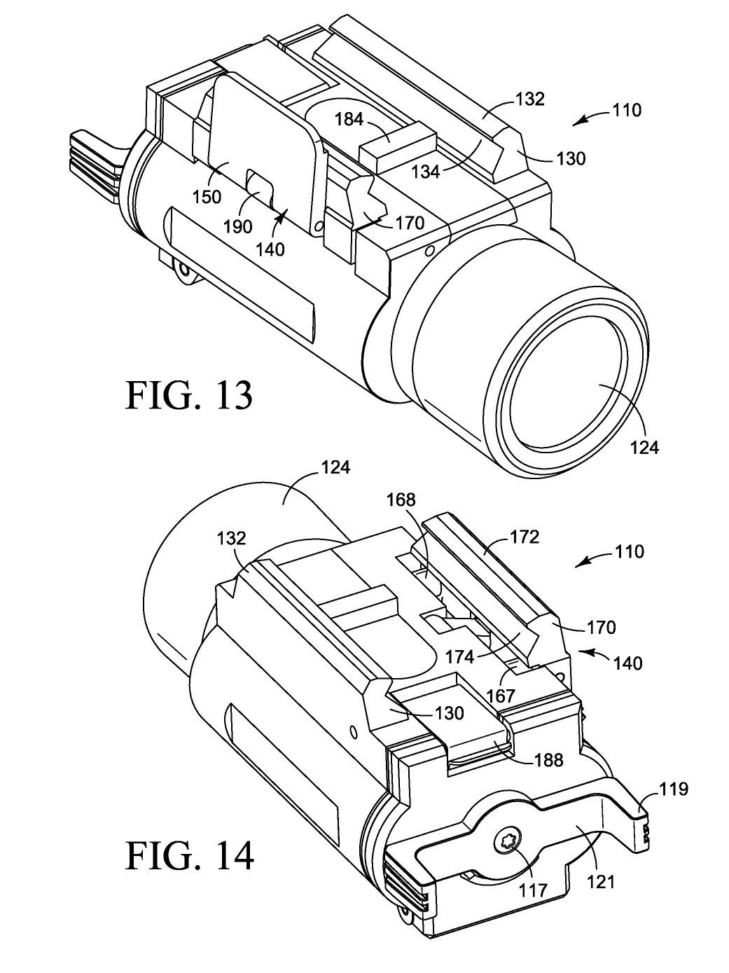

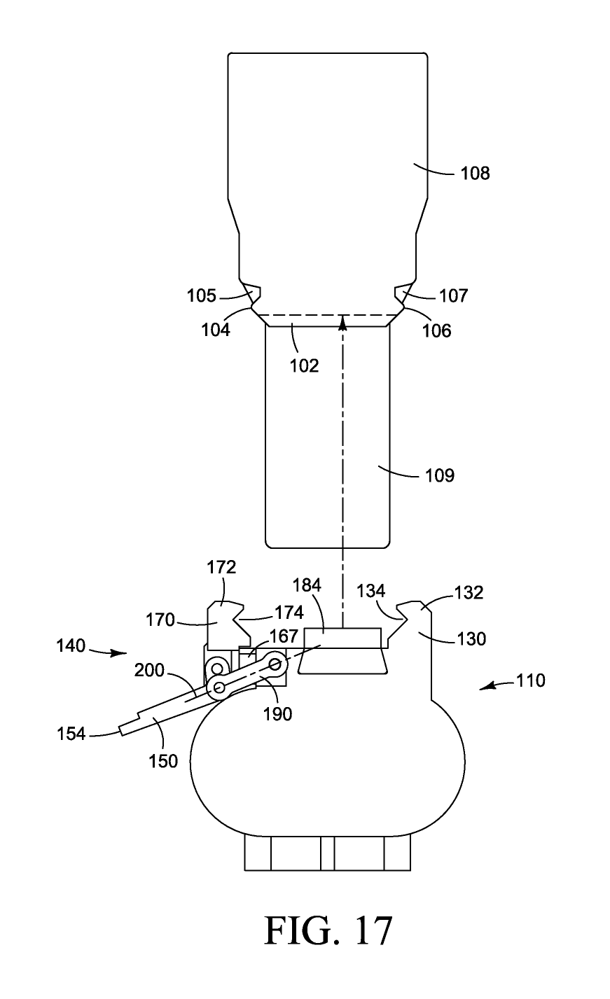

A second exemplary mounting assembly 110 is illustrated in FIGS. 13 through 20. The second exemplary mounting assembly 110 is similar to the first exemplary mounting assembly illustrated in FIGS. 1 though 12, and described above, except as detailed below. Thus, the second exemplary mounting assembly comprises a housing 120, a first arm 130, and a latching arm assembly 140. The mounting assembly 110 for mounting an accessory to a mount, such as the T-shaped rail 102 shown in FIGS. 17 through 20. The housing 120 for housing an accessory and/or connecting with an accessory, such as the illumination means 124 shown in FIGS. 13 through 15. The illumination means 124 can include a front bezel portion which contains a parabolic reflector for directing light from the illumination means 124 in a preferred direction. The mounting assembly 110 thereby allowing the accessory to be mounted onto a mount.

In the second exemplary mounting assembly 110, the accessory comprises an illumination means 124 controlled through use of switch means 121. The illumination means 124 would be powered by one or more energy storage devices (not shown) which can be housed within the housing 120. The switch means 121 shown comprising at least one switch arm 119 able to be manipulated by an operator. Movement (rotation) of the switch arm 119 relative to the switch center pivot 117 allowing the illumination means 124 to be turned on/off, and/or other modes of operation to be selected (e.g., variations of brightness, flashing).

The housing 120 comprising a mounting alignment key 184 located on the top side of the housing 120. This mounting alignment key 184 for receipt into a transversely extending channel (receiver) (not shown) located on the T-shaped rail 2 of the firearm 8. The mounting alignment key 184 for allowing the user to select a desired lateral location of the attached device on the rail 2.

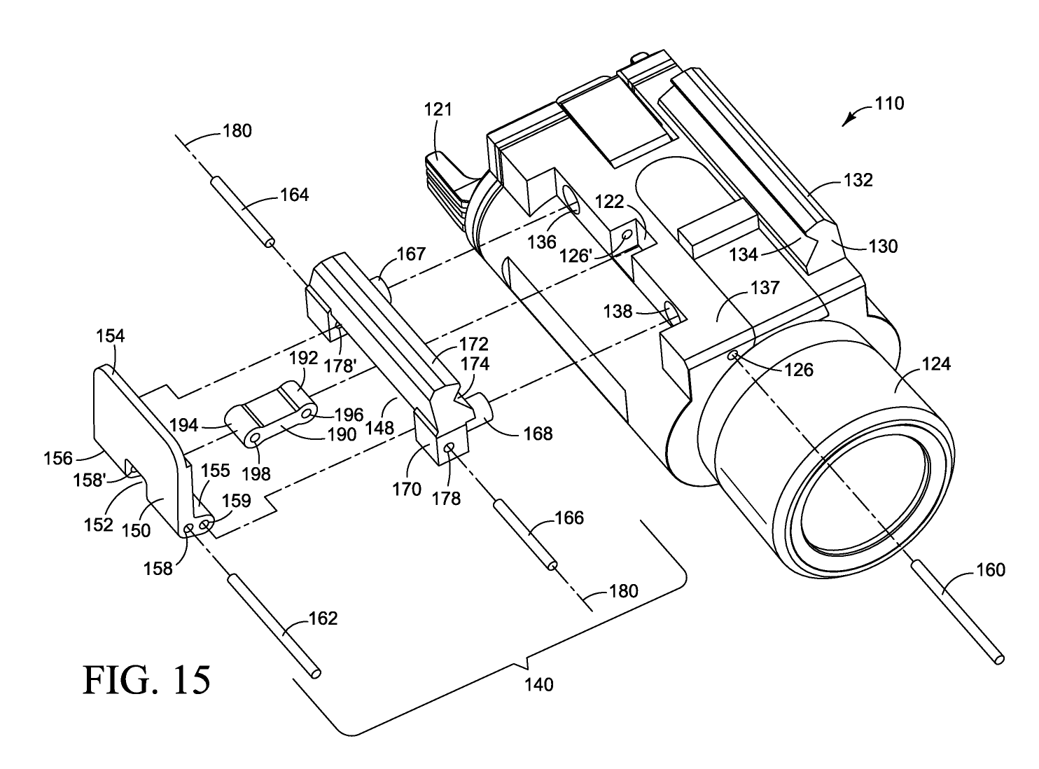

FIG. 15 illustrates the second exemplary mounting assembly in exploded fashion. The mounting assembly 110 comprising a housing 120, a first arm 130, and a latching arm assembly 140. The first arm 130 extending away from the housing 120. As illustrated in FIG. 15, the first arm 130 extending away from the top portion 137 of the housing 120.

The first arm 130 comprising a first jaw 132 and a first notch 134. As illustrated best in FIGS. 17 through 20, the first jaw 132 configured for mating with a corresponding notch 107 on the T-shaped rail 102. The first notch 134 configured for mating with a corresponding opposing flange 106 on the T-shaped rail 102.

While the exemplary mounting assembly illustrates the first arm 130 as being “stationary,” in other exemplary mounting assemblies, the first arm 130 may be movable instead of fixed, for instance, rather than utilizing a single stationary first arm and a movable latching arm, an exemplary mounting assembly could utilize a first arm(s) that is movable.

The latching arm assembly 140 comprises an over center, toggle link style mechanism, comprising a latch release lever 150, a toggle link 190, and a latching arm 170.

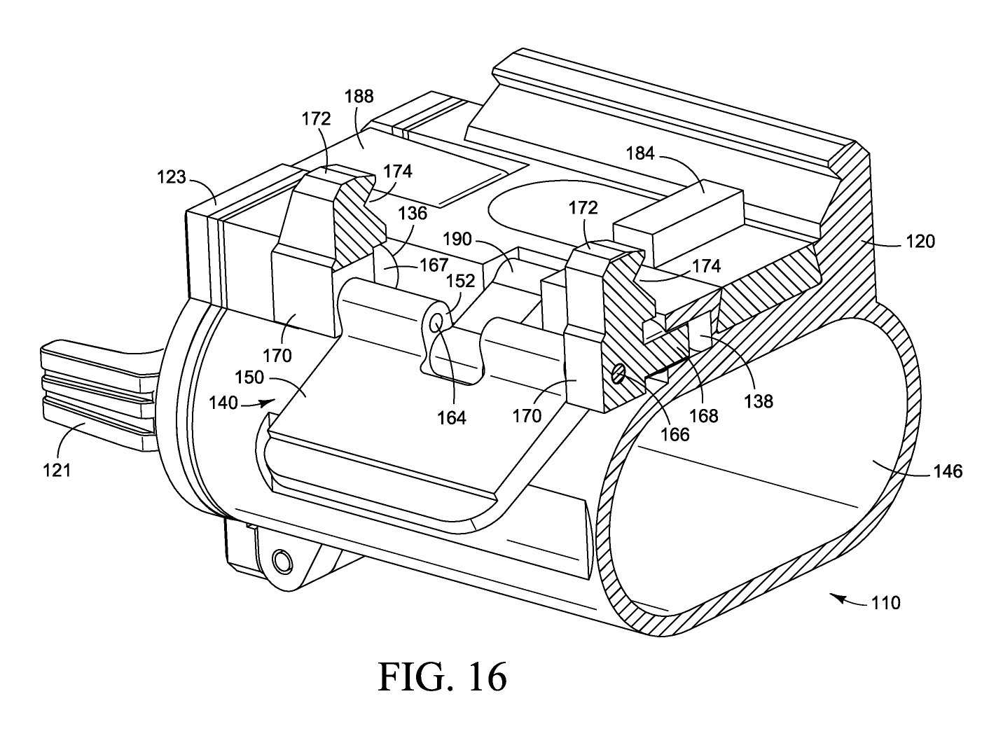

The latching arm 170 connects to the housing 120 at a connection point. The connection point illustrated in FIGS. 13 through 20 being a slidable connection. As best illustrated in FIG. 16, the latching arm assembly 140 slidably connects to the housing 120. In such a configuration, latching arm movement is a linear motion. The housing 120 defining a first guide receiver 136 and a second guide receiver 138. The latching arm assembly 140 comprising a first guide 167 and a second guide 168 extending there-from. The first guide 167 configured for sliding engagement with the first guide receiver 136, the first guide receiver 136 configured for receiving a portion of said first guide 167 therein. The second guide 168 configured for sliding engagement with the second guide receiver 138, the second guide receiver 138 configured for receiving a portion of said second guide 168 therein. When said first and second guides 167, 168 are slidably engaging the first guide receiver 136 and the second guide receiver 138, the latching arm assembly 140 can be slid in a first direction away from the housing, or in a second direction towards the housing.

The toggle link 190 comprising a first end 192 and a second end 194. The first end 192 defining a first end aperture 196 there-through, and said second end 194 defining a second end aperture 198 there-through. The first end aperture 196 configured for receiving an upper housing pin 160 there-through. The second end aperture 198 configured for receiving a toggle pin 162 there-through. The longitudinal axis of the upper housing pin 160 when extending through said first end aperture 196 defining a fourth pivot point 118. The longitudinal axis of the toggle pin 162, when extending through said second end aperture 198, defining a third pivot point 116.

The first end 192 pivotally connected to the housing 120. The second end 194 pivotally connected to the latch release lever 150. The latch release lever 150 pivotally connected to the latching arm 170. The latching arm 170 connected to the housing 120.

In the second exemplary embodiment illustrated in FIGS. 13 through 20, the first end 192 is configured for receipt into a first toggle link receiver 122 defined in the housing 120. The housing 120 defining at least one upper housing aperture 126, 126′ configured for receiving an upper housing pin 160 there-through. The upper housing pin 160 is able to extend through a first upper housing aperture 126, through the first end aperture 196 and into a second upper housing aperture 126′, thereby pivotally connecting the first end 192 to the housing 120 at the first toggle link receiver 122 and defining the fourth pivot point 118.

The second end 194 can be configured for receipt into a second toggle link receiver 152 defined in the latch release lever 150 at the lower end 156 of the latch release lever 150. The latch release lever 150 defining at least one outer aperture 158, 158′ configured for receiving a toggle pin 162 there-through. The toggle pin 162 is able to extend through an outer aperture 158, through the second end aperture 198, and into the outer aperture 158′, thereby pivotally connecting the second end 194 to the latch release lever 150 at the second toggle link receiver 152 and defining the third pivot point 116.

The latch release lever 150 comprising an upper end 154 and a lower end 156. The lower end 156 defining at least one outer aperture 158 and at least one inner aperture 159 there-through. The outer aperture 158 configured for receiving a toggle pin 162 there-through. The inner aperture 159 configured for receiving a second latch pin 166 there-through. The inner aperture 159 defined in an appendage 155 that extends from said lower end 156.

The latch release lever 150 pivotally connected to the latching arm 170. The appendage 155 configured for receipt into a latch release lever receiver 148 defined in the latching arm 170.

The latching arm 170 comprising a latching jaw 172 and a second notch 174. The latching jaw 172 configured for mating with a corresponding notch 105 on the T-shaped rail 102. The second notch 174 configured for mating with a corresponding opposing flange 104 on the T-shaped rail 102. FIGS. 17 through 20 best illustrate this structure and connection.

The latch release lever 150 has an open position and a closed position. FIGS. 13 and 20 illustrate the closed position; whereas FIGS. 12, 14, 16, 17, and 18 illustrate the open position. FIG. 19 illustrates an intermediary position where the latch release lever 150 is moved from the open position to the closed position.

FIGS. 17 though 20 illustrate exemplary steps for mounting the mounting assembly 110 on a firearm 108 having a T-shaped rail 102. In FIG. 17, the mounting assembly 110 is positioned adjacent the T-shaped rail 102 before attachment thereto. The firearm 108 shown in FIG. 17 having a trigger guard 109 in front of which the mounting assembly 110 is positioned. In such a configuration, the switch means 121 is located adjacent the trigger area of the firearm, allowing a user to easily activate the accessory. Some other exemplary mounting assemblies may be configured for mounting at other locations on the firearm 108.

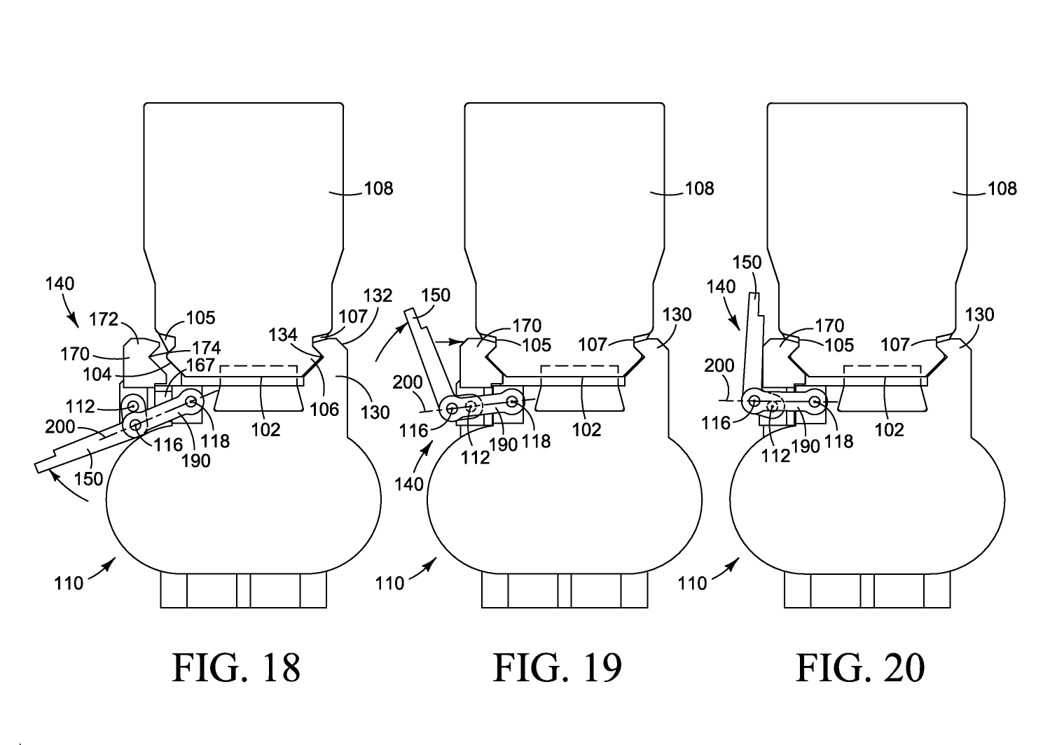

FIG. 18 illustrates the first jaw 132 received into the notch 107 and the opposing flange 106 received into the first notch 134. The latch release lever 150 is shown in its open position. Arrows represent movement of the latch release lever 150 and the corresponding movement of the latching arm 170 and the toggle link 190.

As shown in the transition from FIG. 18 to FIG. 19, as the latch release lever 150 is moved in a second direction, the latch release lever 150 rotates around the first pivot point 112 where the latch release lever 150 connects with the latching arm 170. The latch release lever 150 pivotally connects with the toggle link 190 at the third pivot point 116. Rotation around the first pivot point 112 results in rotation of the third pivot point 116 relative to the first pivot point 112. Rotation of the third pivot point 116 relative to the first pivot point 112 causes the second end 194 of the toggle link 190 to be drawn towards the housing 120 thereby causing the latching arm 170 to slide, via the first and second guides 167, 168 sliding within the first guide receiver 136 and the second guide receiver 138, towards the T-shaped rail 102 (and towards the first jaw 132), bringing the latching jaw 172 and second notch 174 into engagement with the notch 105 and opposing flange 104 of the rail 102, as best illustrated in FIG. 19.

Further movement of the latch release lever 150 in a first direction to the closed position, as illustrated in FIG. 20, results in the third pivot point 116 rotating around the first pivot point 112 and bringing the first pivot point 112 into an over-center position relative to the toggle link axis 200. The toggle link axis 200 defined between the third pivot point 116 and the fourth pivot point 118. In this over-center position, the latch release lever 150 is locked into its closed position, with the latching jaw 172 and first jaw 132 releasably clamped onto the T-shaped rail 102 between the latching jaw 172 and the first jaw 132.

To detach the mounting assembly 110 from the firearm 108, the process is reversed, with the upper end 154 of the latch release lever 150 moved away from the housing and into its open position. This results in the latching jaw 172 moving away from the first jaw 132, and the first pivot point 112 moving out of its over-center position relative to the toggle link axis 200. Further movement of the latch release lever 150 away from the housing (rotating the latch release lever 150 around the first pivot point 112, results in the latching jaw 173 disengaging from the T-shaped rail 102 and moving away there-from.

In a third exemplary mounting assembly, the mounting assembly comprises a housing, a first arm, and a latching arm assembly. The mounting assembly for mounting an accessory to a mount. The latching arm assembly comprises an over center, toggle link style mechanism, comprising a latch release lever, a toggle link, and a latching arm. The toggle link comprising a first end and a second end. The first end pivotally connects to the housing. The second end pivotally connects to the latch release lever. The latch release lever pivotally connects to the latching arm. The latching arm connects to the housing.

In a fourth exemplary mounting assembly, the mounting assembly comprises a housing, a first arm, and a latching arm assembly. The mounting assembly for mounting an accessory to a mount. The latching arm assembly comprises an over center, toggle link style mechanism, comprising a latch release lever, a toggle link, and a latching arm. The toggle link comprising a first end and a second end. The first end pivotally connects to the housing. The second end pivotally connects to the latch release lever. The latch release lever pivotally connects to the latching arm. The latching arm pivotally connects to the housing.

In a fifth exemplary mounting assembly, the mounting assembly comprises a housing, a first arm, and a latching arm assembly. The mounting assembly for mounting an accessory to a mount. The latching arm assembly comprises an over center, toggle link style mechanism, comprising a latch release lever, a toggle link, and a latching arm. The toggle link comprising a first end and a second end. The first end pivotally connects to the housing. The second end pivotally connects to the latch release lever. The latch release lever pivotally connects to the latching arm. The latching arm slidably connects to the housing.

While “firearm” is used as the example object having a T-shaped rail to which the accessory is mounted using the exemplary mounting assemblies, the disclosed mounting assemblies can be configured for attachment to other objects. Likewise, while a “T-shaped” rail is described as one configuration of rail to which the disclosed mounting assemblies can be configured for attachment to, use of such a term herein is not intended to limit the applicability of the invention to such a rail shape or configuration.

The first arm is described herein and illustrated in the drawings as being “stationary” and not movable. In other exemplary mounting assemblies, the first arm may be movable instead of fixed (stationary). For instance, rather than utilizing a stationary first arm and a movable latching arm, an exemplary mounting assembly could utilize two or more movable latching arms.

Any suitable structure and/or material can be used for the mounting assembly, and a skilled artisan will be able to select an appropriate structure and material for the mounting assembly in a particular embodiment based on various considerations, including the intended use of the mounting assembly, the intended environment within which the mounting assembly will be used, and the equipment and/or accessories with which the mounting assembly is intended to be used, among other considerations.

The inventors have determined that conventional polymeric and metal materials are suitable for use in the various components of the mounting assembly. For example, the mounting assembly and associated components can be injection-molded from suitable plastics known in the art; and/or the mounting assembly and associated components can be formed from metal materials, including aluminum, steel, stainless steel and other suitable metals. It is not necessary for all of the various components of the mounting assembly to be comprised of the same material, for instance, both polymeric and metal materials can be used in the same mounting assembly. Materials hereinafter discovered and/or developed that are determined to be suitable for use in mounting assembly devices would also be considered suitable for use in a mounting assembly according to a particular embodiment.

The foregoing detailed description provides exemplary embodiments of the invention and includes the best mode for practicing the invention. The description and illustration of these embodiments is intended only to provide examples of the invention, and not to limit the scope of the invention, or its protection, in any manner.

What is claimed is:

1. A mounting assembly, said mounting assembly configured for mounting to a rail, said mounting assembly comprising:
a housing;
a first arm comprising a first jaw, said first arm connecting to said housing; and
a latching arm assembly, wherein said latching arm assembly comprises a latch release lever, a toggle link, and a latching arm, said latching arm connecting to said housing, said toggle link comprising a first end and a second end, said first end pivotally connecting to said housing, said second end pivotally connecting to said latch release lever, and said latch release lever pivotally connecting to said latching arm, said latching arm comprising a latching jaw;
wherein said latching arm assembly comprises an over center, toggle link style mechanism; and
wherein when mounted on said rail, said rail is held clamped between the first jaw and the latching jaw.

2. A mounting assembly, said mounting assembly configured for mounting to a generally T-shaped rail, said mounting assembly comprising a housing, a first arm and a latching arm assembly, wherein:
said first arm extending from said housing, said first arm comprising a first jaw; and
said latching arm assembly connected to said housing at a connection point, said latching arm assembly comprising a latch release lever, a latching arm, and a toggle link, said toggle link comprising a first end and a second end, said first end pivotally connecting to a first toggle link receiver defined in said housing at a fourth pivot point, said second end pivotally connecting to a second toggle link receiver defined in said latch release lever at a third pivot point, said latch release lever pivotally connecting to said latching arm at a first pivot point, said latch release lever defining an open position and a closed position, said latch release lever comprising an upper end and a lower end, and said latching arm comprising a latching jaw;
wherein said latch release lever upper end can be manipulated by a user in a first direction from said closed position to said open position, whereby when moved in said first direction said latch release lever pivots around said first pivot point resulting in movement of the latching arm at said connection point thereby causing the latching jaw to move away from the first jaw;
wherein said latch release lever upper end can be manipulated by a user in a second direction from said open position to said closed position, whereby when moved in said second direction said latch release lever pivots around said first pivot point resulting in movement of the latching arm at said connection point thereby causing the latching jaw to move towards the first jaw; and
wherein when in said closed position, said T-shaped rail is clamped between said latching jaw and said first jaw.

3. The mounting assembly of claim 2, wherein when moving from said closed position to said open position, said first pivot point passes between said third and fourth pivot points, rotates relative to said third pivot point, and moves away from said fourth pivot point.

4. The mounting assembly of claim 2, wherein when moving from said open position to said closed position, said first pivot passes between said third pivot point and said fourth pivot point.

5. The mounting assembly of claim 4, wherein when in said closed position, said first pivot point is in an over-center lock position.

6. The mounting assembly of claim 2, wherein said latching arm pivotally connects to said housing via a lower housing pin extending through apertures in said latching arm and said housing.

7. The mounting assembly of claim 2, wherein said housing comprises an illumination means.

8. The mounting assembly of claim 2, wherein said first jaw defines a first notch and said latching jaw defines a second notch, said notches configured for mating with opposing flanges extending from said T-shaped rail.

9. The mounting assembly of claim 2, wherein said first end pivotally connects to said first toggle link receiver defined in said housing via an upper housing pin extending through apertures in said housing and said toggle link first end; and
wherein said second end pivotally connects to said second toggle link receiver defined in said latch release lever via a lower toggle pin extending through apertures in said latch release lever and said toggle link second end.

10. The mounting assembly of claim 2, wherein said latch release lever pivotally connects to said latching arm via a first latch pin and a second latch pin extending through apertures in said latching arm and said latch release lever.

11. The mounting assembly of claim 2, wherein said latching arm assembly pivotally connects to said housing at a second pivot point, and wherein the movement of the latching arm comprises rotation of the latching arm at said second pivot point.

12. A mounting assembly, said mounting assembly configured for mounting to a generally T-shaped rail, said mounting assembly comprising a housing, a first arm and a latching arm assembly, wherein:
said first arm extending from said housing, said first arm comprising a first jaw; and
said latching arm assembly connected to said housing at a connection point, said latching arm assembly comprising a latch release lever, a latching arm, and a toggle link, said toggle link comprising a first end and a second end, said first end pivotally connecting to a first toggle link receiver defined in said housing at a fourth pivot point, said second end pivotally connecting to a second toggle link receiver defined in said latch release lever at a third pivot point, said latch release lever pivotally connecting to said latching arm at a first pivot point, said latch release lever defining an open position and a closed position, said latch release lever comprising an upper end and a lower end, and said latching arm comprising a latching jaw;
wherein said latch release lever upper end can be manipulated by a user in a first direction from said closed position to said open position, whereby when moved in said first direction said latch release lever pivots around said first pivot point resulting in movement of the latching arm at said connection point thereby causing the latching jaw to move away from the first jaw;
wherein said latch release lever upper end can be manipulated by a user in a second direction from said open position to said closed position, whereby when moved in said second direction said latch release lever pivots around said first pivot point resulting in movement of the latching arm at said connection point, thereby causing the latching jaw to move towards the first jaw;
wherein when in said closed position, said T-shaped rail is clamped between said latching jaw and said first jaw; and
wherein when moving from said open position to said closed position, said first pivot passes between said third pivot point and said fourth pivot point, and wherein when in said closed position, said first pivot point is in an over-center lock position.

13. The mounting assembly of claim 12, wherein when moving from said closed position to said open position, said first pivot point passes between said third and fourth pivot points, rotates relative to said third pivot point, and moves away from said fourth pivot point.

14. The mounting assembly of claim 12, wherein said latching arm pivotally connects to said housing via a lower housing pin extending through apertures in said latching arm and said housing.

15. The mounting assembly of claim 12, wherein said housing comprises an illumination means.

16. The mounting assembly of claim 12, wherein said first jaw defines a first notch and said latching jaw defines a second notch, said notches configured for mating with opposing flanges extending from said T-shaped rail.

17. The mounting assembly of claim 12, wherein said first end pivotally connects to said first toggle link receiver defined in said housing via an upper housing pin extending through apertures in said housing and said toggle link first end, and wherein said second end pivotally connects to said second toggle link receiver defined in said latch release lever via a lower toggle pin extending through apertures in said latch release lever and said toggle link second end.

18. The mounting assembly of claim 12, wherein said latch release lever pivotally connects to said latching arm via a first latch pin and a second latch pin extending through apertures in said latching arm and said latch release lever, and wherein said first latch pin and said second latch pin are generally aligned along a longitudinal axis.

19. The mounting assembly of claim 12, wherein said latching arm pivotally connects to said housing at a second pivot point, and wherein the movement of the latching arm comprises rotation of the latching arm at said second pivot point.

20. The mounting assembly of claim 12, wherein said latching arm slidably connects to said housing, and wherein the movement of the latching arm comprises linear motion of the latching arm.
